(19) United States
(12) Patent Application Publication
(10) Pub. No.: US 2021/0049274 A1
(43) Pub. Date: Feb. 18, 2021

(54) ANALYSIS DEVICE, ANALYSIS METHOD, AND RECORDING MEDIUM

(71) Applicant: NEC Corporation, Minato-ku, Tokyo (JP)

(72) Inventor: Satoshi IKEDA, Tokyo (JP)

(73) Assignee: NEC Corporation, Minato-ku, Tokyo (JP)

(21) Appl. No.: 16/964,414

(22) PCT Filed: Mar. 15, 2018
(86) PCT No.: PCT/JP2018/010288

§ 371 Date: Jul. 23, 2020

(51) Int. Cl. G06F 21/56; G06F 21/54; G06K 9/62

(52) U.S. Cl. CPC G06F 21/565; G06F 21/566; G06K 9/6262; G06F 21/54; G06F 21/568

(57) ABSTRACT

A search in threat hunting can be efficiently performed. An analysis device includes a model generation unit and a display unit. The model generation unit generate a model of outputting information relating to an operation to be performed on an element, based on learning data including an operation performed on a displayed element, and a display history of an element up until the displayed element is displayed. The display unit displays an element, and information acquired from the model and relating to an operation to be performed on the element.

### TECHNICAL FIELD

The present invention relates to an analysis device, an analysis method, and a recording medium.

### BACKGROUND ART

A security measure by defense in depth in which a plurality of measures are taken in multiple layers is starting to diffuse as a measure against a threat such as malware in information security. However, when security equipment fails to cope with a new attack, a threat may intrude. Once intrusion by a threat is incurred, it often takes time to find the threat or deal with the threat. Thus, threat hunting that finds a thread intruding into a network of a company or the like and hiding is important.

In the threat hunting, an analyst detects, by use of an analysis device, a suspicious program (a program having a possibility of a threat) operating at an end point such as a server device or a terminal device, based on event information collected at the end point. For example, the analyst searches for a suspicious program by repeating such an operation as retrieving, from the event information, a program, and a file, a registry, or the like being accessed by the program, and checking various pieces of information relating to a retrieval result. The analyst is required to efficiently perform such a search on a huge volume of event information collected at an end point. Such a search is influenced by analytical knowledge and analytical experience, and even a user having insufficient knowledge and experience is required to efficiently perform a search.

A technique related to improvement in efficiency of an operation in a search is disclosed in, for example, PTL 1. A machine-learning apparatus described in PTL 1 learns display of a menu item, based on an operation history of the menu item, and determines a position and an order of the menu item, based on a learning result.

### CITATION LIST

### Patent Literature

[PTL 1] Japanese Unexamined Patent Application Publication No. 2017-138881

### SUMMARY OF INVENTION

### Technical Problem

The technique described in PTL 1 above determines a position and an order of a menu item, but does not present information relating to an operation to be performed for a menu item, such as which menu item to be operated with priority. Thus, even when the technique described in PTL 1 is applied to threat hunting, a search on a huge volume of event information fails to be efficiently performed.

An object of the present invention is to provide an analysis device, an analysis method, and a recording medium for solving the problem described above, and efficiently performing a search in threat hunting.

### Solution to Problem

An analysis device according to one aspect of the present invention includes: a model generation means for generating a model of outputting information relating to an operation to be performed on a check target, based on learning data including an operation performed on a displayed check target, and a display history of a check target up until the displayed check target is displayed; and a display means for displaying a check target, and information acquired from the model and relating to an operation to be performed on the check target.

An analysis method according to one aspect of the present invention includes: generating a model of outputting information relating to an operation to be performed on a check target, based on learning data including an operation performed on a displayed check target, and a display history of a check target up until the displayed check target is displayed; and displaying a check target, and information acquired from the model and relating to an operation to be performed on the check target.

A computer-readable recording medium according to one aspect of the present invention stores a program causing a computer to execute processing of: generating a model of outputting information relating to an operation to be performed on a check target, based on learning data including an operation performed on a displayed check target, and a display history of a check target up until the displayed check target is displayed; and displaying a check target, and information acquired from the model and relating to an operation to be performed on the check target.

### Advantageous Effects of Invention

An advantageous effect of the present invention is that a search in threat hunting can be efficiently performed.

### BRIEF DESCRIPTION OF DRAWINGS

FIG. 1 is a block diagram illustrating a configuration of an analysis device 100 according to a first example embodiment.

FIG. 2 is a block diagram illustrating a configuration of the analysis device 100 implemented on a computer, according to the first example embodiment.

FIG. 3 is a diagram illustrating an example of a terminal log according to the first example embodiment.

FIG. 4 is a diagram illustrating another example of a terminal log according to the first example embodiment.

FIG. 5 is a diagram illustrating another example of a terminal log according to the first example embodiment.

FIG. 6 is a flowchart illustrating learning processing according to the first example embodiment.

FIG. 7 is a diagram illustrating an example of an operation history generated in learning processing according to the first example embodiment.

FIG. 8 is a diagram illustrating an example of a screen generated in learning processing according to the first example embodiment.

FIG. 9 is a diagram illustrating another example of a screen generated in learning processing according to the first example embodiment.

FIG. 10 is a diagram illustrating another example of a screen generated in learning processing according to the first example embodiment.

FIG. 11 is a diagram illustrating a relation between lists generated in learning processing according to the first example embodiment.

FIG. 12 is a diagram illustrating a configuration of a feature vector according to the first example embodiment.

FIG. 13 is a diagram illustrating an example of a feature vector generated in learning processing according to the first example embodiment.

FIG. 14 is a diagram illustrating an example of learning data according to the first example embodiment.

FIG. 15 is a flowchart illustrating proposition processing according to the first example embodiment.

FIG. 16 is a diagram illustrating an example of an operation history generated in proposition processing according to the first example embodiment.

FIG. 17 is a diagram illustrating an example of a screen generated in proposition processing according to the first example embodiment.

FIG. 18 is a diagram illustrating another example of a screen generated in proposition processing according to the first example embodiment.

FIG. 19 is a diagram illustrating an example of a feature vector generated in proposition processing according to the first example embodiment.

FIG. 20 is a block diagram illustrating a characteristic configuration of the first example embodiment.

FIG. 21 is a diagram illustrating an example of an operation history generated in learning processing according to a second example embodiment.

FIG. 22 is a diagram illustrating an example of learning data according to the second example embodiment.

FIG. 23 is a diagram illustrating an example of a screen generated in proposition processing according to the second example embodiment.

FIG. 24 is a diagram illustrating another example of a screen generated in proposition processing according to the second example embodiment.

FIG. 25 is a diagram illustrating another example of a screen generated in proposition processing according to the second example embodiment.

FIG. 26 is a diagram illustrating another example of a screen generated in proposition processing according to the second example embodiment.

### EXAMPLE EMBODIMENT

Example embodiments of the invention will be described in detail with reference to the drawings. The same reference sign is assigned to a similar component in each of the drawings and each of the example embodiments described in the description, and description of the component is omitted appropriately.

### First Example Embodiment

First, a configuration according to a first example embodiment is described.

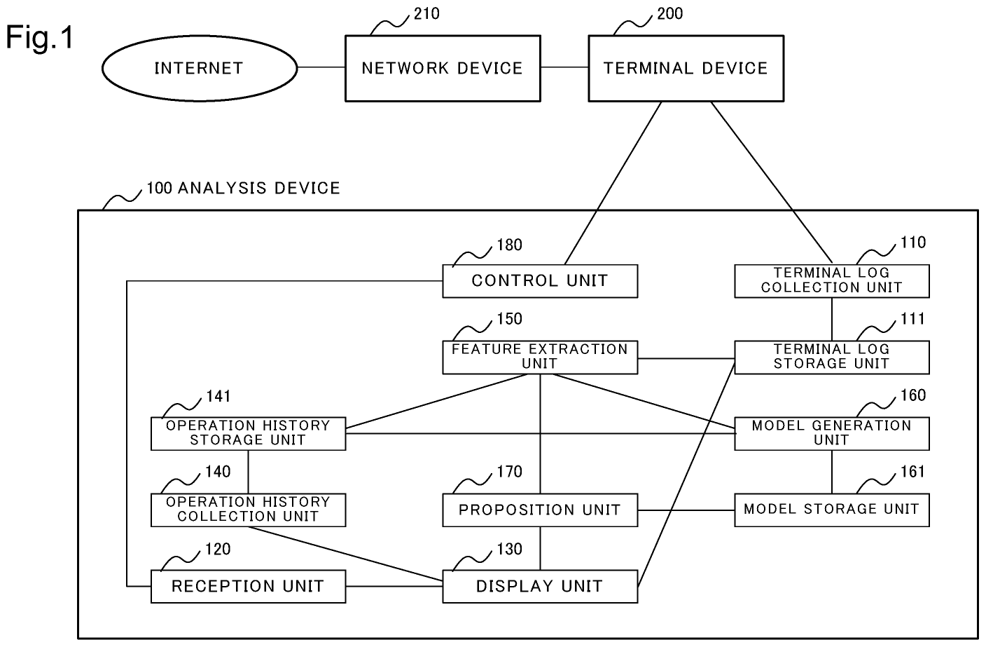

FIG. 1 is a block diagram illustrating a configuration of an analysis device 100 according to the first example embodiment.

Referring to FIG. 1, the analysis device 100 according to the first example embodiment is connected to a terminal device 200 via a network or the like.

In threat hunting, the analysis device 100 assists a search by a user such as an analyst for a suspicious program (a program having a possibility of a threat) using a terminal log. A case where an execution unit of the program is a process is described below as an example, but an execution unit of the program may be a task, a job, or the like. The terminal log is a log (event log) indicating an event relating to an analysis target such as a process operating on the terminal device 200, a file or a registry accessed by a process, or the like.

The analysis device 100 displays an element being information indicating an analysis target. An element is a target that the user checks in threat hunting. Hereinafter, an element is also described as a “check target”. An element includes an identifier (ID) of a check target.

The analysis device 100 performs an operation on a displayed element, in accordance with an order from the user, and displays a result of the operation to the user. Herein, the operation includes extraction of detailed information of an analysis target indicated by an element from the terminal log, and retrieval of another analysis target related to the analysis target indicated by the element. Moreover, the operation includes giving of an analysis result (a determination result of whether the analysis target is a suspicious analysis target) to the analysis target indicated by the element.

The analysis device 100 presents, to the user, information relating to an operation to be performed on the element. Hereinafter, information relating to an operation to be performed on the element is also described as “proposition information”. In the first example embodiment, an “importance degree of an operation” is output as proposition information.

The terminal device 200 is equivalent to an end point in threat hunting. The terminal device 200 is, for example, a computer connected to a network, such as a personal computer, a mobile terminal, or a server device. The terminal device 200 may be connected to a private network such as an intranet of a company. In this case, the terminal device 200 may be accessible to a public network such as the Internet via a network device 210 such as a firewall, as illustrated in FIG. 1. The terminal device 200 may be connected to a public network such as the Internet.

The terminal device 200 monitors an event relating to an analysis target, and transmits information about the event as a terminal log to the analysis device 100. The terminal device 200 may transmit the terminal log to the analysis device 100 via a log collection device (not illustrated) or the like, instead of directly transmitting the terminal log to the analysis device 100.

The analysis device 100 includes a terminal log collection unit 110, a reception unit 120, a display unit 130, an operation history collection unit 140, a feature extraction unit 150, a model generation unit 160, a proposition unit 170, and a control unit 180. Further, the analysis device 100 includes a terminal log storage unit 111, an operation history storage unit 141, and a model storage unit 161.

The terminal log collection unit 110 collects a terminal log from the terminal device 200.

The terminal log storage unit 111 stores the terminal log collected by the terminal log collection unit 110.

The reception unit 120 receives, from the user, an execution order for an operation relating to an element.

The display unit 130 executes the operation ordered from the user, and generates and displays a screen including a result of the execution. The display unit 130 gives, to an element in the screen, proposition information output from the proposition unit 170, and then displays the proposition information. Herein, the display unit 130 gives an importance degree of an operation as the proposition information.

The operation history collection unit 140 collects a history of an operation (hereinafter, also described as an “operation history”) for the element.

The operation history storage unit 141 stores the operation history collected by the operation history collection unit 140.

The feature extraction unit 150 generates a feature vector for each element included in the operation history, based on the operation history and the terminal log. The feature vector includes a feature relating to an analysis target indicated by each element in a display history of an element up until the element is displayed.

The model generation unit 160 generates learning data, based on an operation history and a feature vector. The model generation unit 160 generates a model of outputting proposition information for an element, by performing machine learning for the generated learning data. Herein, the model generation unit 160 generates a model of calculating an importance degree of an operation as proposition information.

The model storage unit 161 stores a model generated by the model generation unit 160.

The proposition unit 170 determines proposition information for an element by use of the model, and outputs the proposition information to the display unit 130. Herein, the proposition unit 170 calculates an importance degree of an operation as proposition information.

The control unit 180 performs protection control over the terminal device 200 and the network device 210.

The analysis device 100 may be a computer including a central processing unit (CPU) and a recording medium storing a program, and operating by control based on the program.

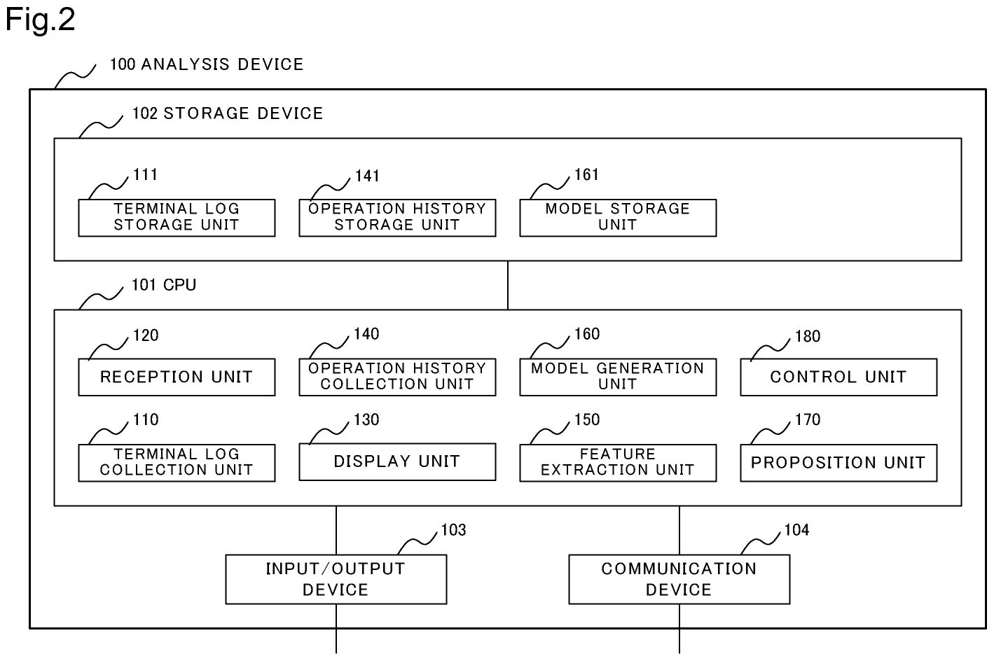

FIG. 2 is a block diagram illustrating a configuration of the analysis device 100 implemented on a computer, according to the first example embodiment.

Referring to FIG. 2, the analysis device 100 includes a CPU 101, a storage device 102 (recording medium), an input/output device 103, and a communication device 104. The CPU 101 executes an instruction of a program for implementing the terminal log collection unit 110, the reception unit 120, the display unit 130, the operation history collection unit 140, the feature extraction unit 150, the model generation unit 160, the proposition unit 170, and the control unit 180. The storage device 102 is, for example, a hard disk, a memory, or the like, and stores data of the terminal log storage unit 111, the operation history storage unit 141, and the model storage unit 161. The input/output device 103 is, for example, a keyboard, a display, or the like, and outputs, to the user or the like, a screen generated by the display unit 130. The input/output device 103 receives, from the user or the like, an input of an operation relating to an element. The communication device 104 receives a terminal log from the terminal device 200. The communication device 104 transmits, to the terminal device 200 or the network device 210, an order for protection control by the control unit 180.

Some or all of the components of the analysis device 100 may be implemented by a general-purpose or dedicated circuitry or processor, or a combination of these. The circuitry or processor may be constituted of a single chip or a plurality of chips connected via a bus. Some or all of the components may be implemented by a combination of the above-described circuitry or the like and a program. When some or all of the components are implemented by a plurality of information processing devices, circuitries, or the like, the plurality of information processing devices, circuitries, or the like may be concentratedly arranged or distributedly arranged. For example, the information processing devices, circuitries, or the like may be implemented as a form such as a client-and-server system, a cloud computing system, or the like in which each of the information processing devices, circuitries, or the like is connected via a communication network.

Next, an operation of the analysis device 100 according to the first example embodiment is described.

<Learning Processing>

First, learning processing by the analysis device 100 is described. The learning processing is processing of generating a model for outputting proposition information, based on an operation history generated during a search. The learning processing is performed during a search by a user having rich knowledge and experience, for example.

Herein, it is assumed that a terminal log for a period of a predetermined length collected from the terminal device 200 by the terminal log collection unit 110 is previously stored in the terminal log storage unit 111.

The terminal device 200 monitors an event relating to an analysis target (a process, a file, a registry, or the like) on the terminal device 200. For example, when an operating system (OS) operating on the terminal device 200 is Windows (registered trademark), the terminal device 200 monitors, as an event, activation or termination of a process, acquisition of a process handle, creation of a remote thread, and the like. Further, the terminal device 200 may monitor, as an event, a communication with another device by a process, an inter-process communication, an access to a file or a registry, indicators of attack, and the like. Herein, the inter-process communication is, for example, a communication performed between processes via a named pipe or socket, a window message, a shared memory, or the like. The indicators of attack are, for example, events having a possibility of an attack by a threat, such as a communication with a specific external communication destination, activation of a specific process, an access to a file of a specific process, and information generation for automatically executing a specific process. Even when an OS is not Windows, the terminal device 200 monitors a similar event for an execution unit such as a process, a task, or a job.

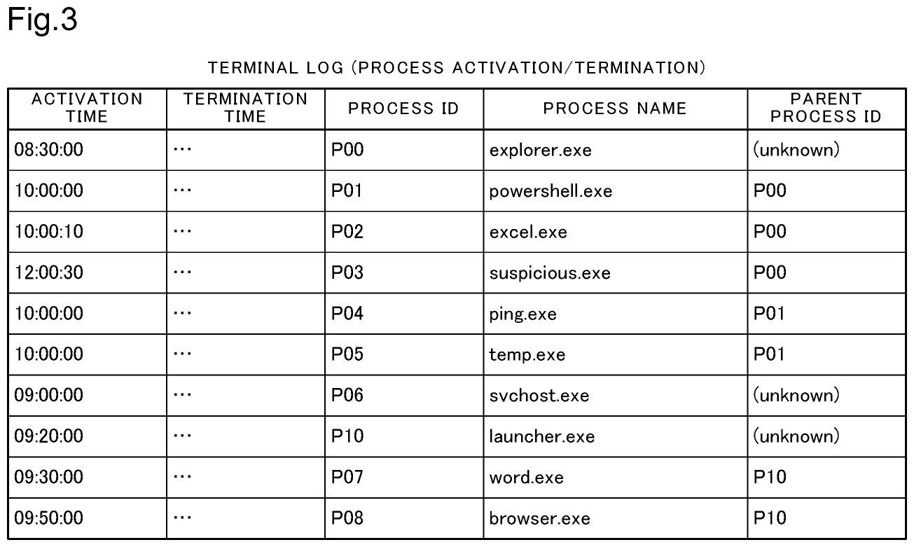

FIGS. 3, 4, and 5 are diagrams each illustrating an example of a terminal log according to the first example embodiment.

FIG. 3 is an example of a log relating to activation/termination of a process. In the example of FIG. 3, an activation time and an termination time of a process, a process ID and a process name of the process, and a process ID (parent process ID) of a parent process activating the process are registered as a log.

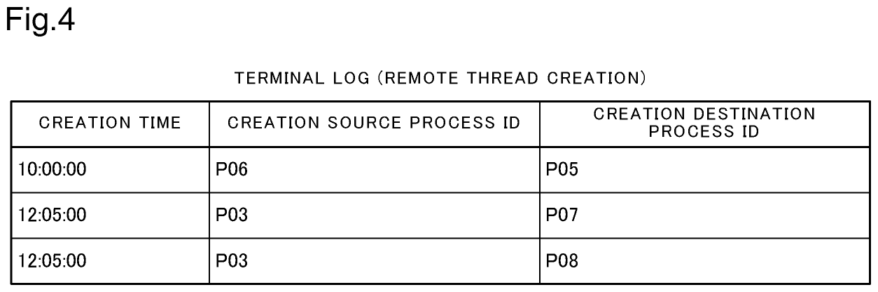

FIG. 4 is an example of a log relating to creation of a remote thread. In the example of FIG. 4, a creation time of a remote thread, and a process ID (creation source process ID) of a creation source process and a process ID (creation destination process ID) of a creation destination process of the remote thread are registered as a log. In relation to acquisition of a process handle as well, an acquisition time of a process handle, and a process ID of an acquisition source process and a process ID of an acquisition destination process of the process handle are similarly registered.

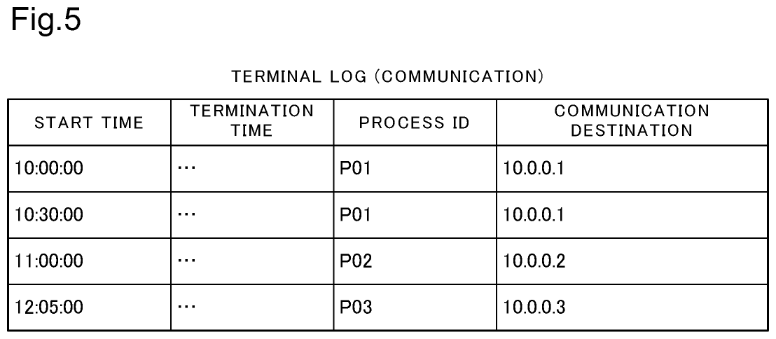

FIG. 5 is an example of a log relating to communication. In the example of FIG. 5, a start time and an end time of a communication by a process, a process ID of the process, and an Internet protocol (IP) address indicating a communication destination are registered as a log.

For example, it is assumed that terminal logs as in FIGS. 3 to 5 are stored in the terminal log storage unit 111 as terminal logs.

When a plurality of processes (instances having different process IDs) having the same process name can be activated, the processes are identified as different processes for each instance.

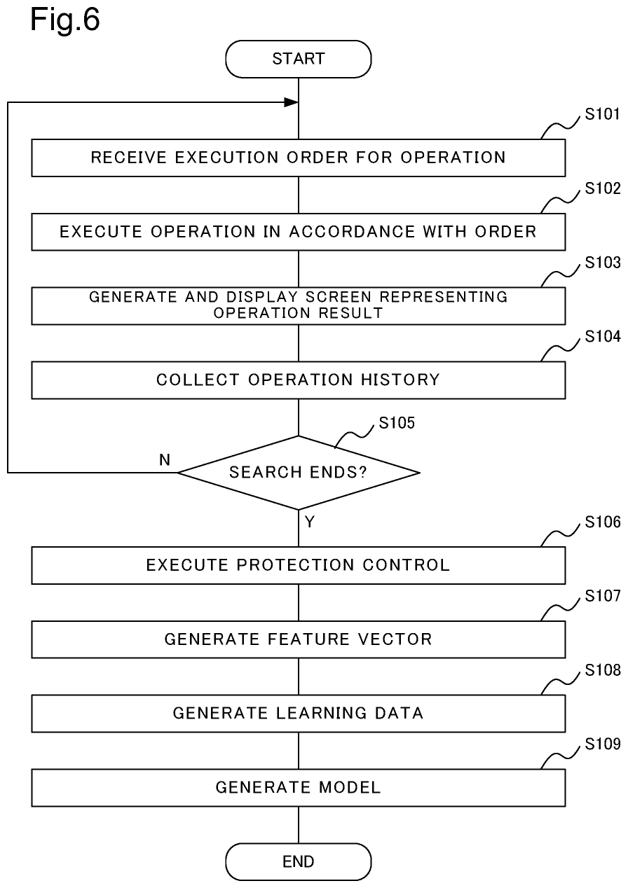

FIG. 6 is a flowchart illustrating learning processing according to the first example embodiment.

In learning processing, processing in the following steps S101 to S105 is performed during a search by a user.

The reception unit 120 receives, from the user, an execution order for an operation relating to an element (step S101).

The display unit 130 executes the operation in accordance with the order (step S102).

The display unit 130 generates and displays a screen representing a result of the operation (step S103).

The operation history collection unit 140 collects an operation history of the executed operation (step S104). The operation history collection unit 140 saves the collected operation history in the operation history storage unit 141. When a plurality of times of operations are executed for the same element, the operation history collection unit 140 overwrites the operation history with an operation executed later.

The analysis device 100 repeats the processing in steps S101 to S104 up until the search ends (step S105). The end of the search is ordered by the user, for example.

Specific examples of the steps S101 to S105 are described below.

Herein, “display”, “check”, “determination (benign)”, and “determination (malignant)” are defined as operations relating to an element.

The operation “display” means retrieving, from a terminal log, analysis targets conforming to a retrieval condition, and displaying a list of elements indicating the analysis targets. The retrieval condition is designated by a character string, or a relevancy to an analysis target indicated by a displayed element.

The operation “check” means extracting, from a terminal log, and displaying detailed information of an analysis target indicated by a displayed element.

The operation “determination (benign)” means giving a determination result “benign” to an analysis target indicated by a displayed element. Herein, a determination result being “benign” indicates that the analysis target is determined to be unsuspicious.

The operation “determination (malignant)” means giving a determination result “malignant” to an analysis target indicated by a displayed element. Herein, a determination result being “malignant” indicates that the analysis target is determined to be suspicious.

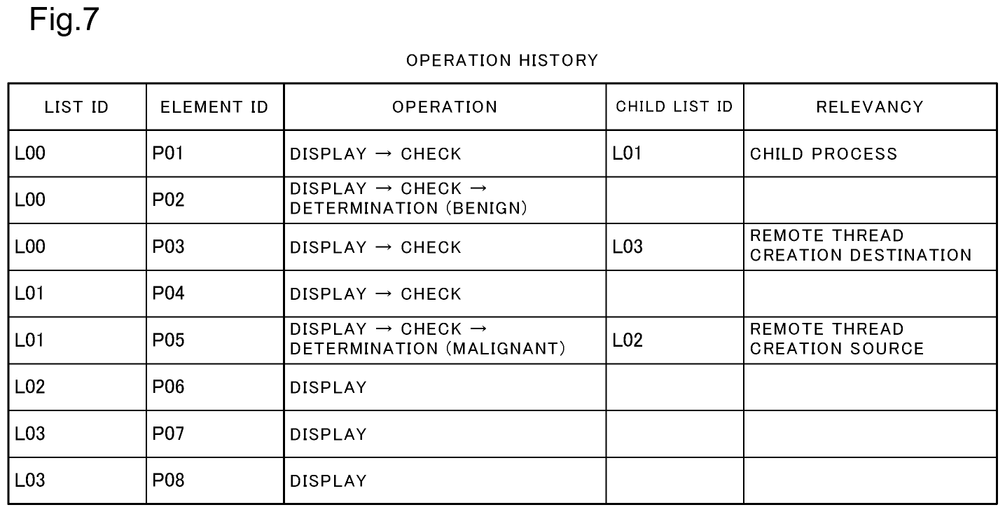

FIG. 7 is a diagram illustrating an example of an operation history generated in learning processing according to the first example embodiment.

In the example of FIG. 7, an ID of a list (list ID), an ID (element ID) of an element in the list, and an operation executed for the element are associated with one another as an operation history. Herein, for example, an ID (a process ID, a file ID, a registry ID, or the like) of an analysis target indicated by the element is used for the element ID. Further, an ID (child list ID) of a list of an element acquired by retrieval, and a relevancy to a child list (relevancy) are associated with the element for which retrieval in the operation “display” is performed. An arrow illustrated together with an operation indicates that an operation on a left side of the arrow is overwritten with an operation on a right side.

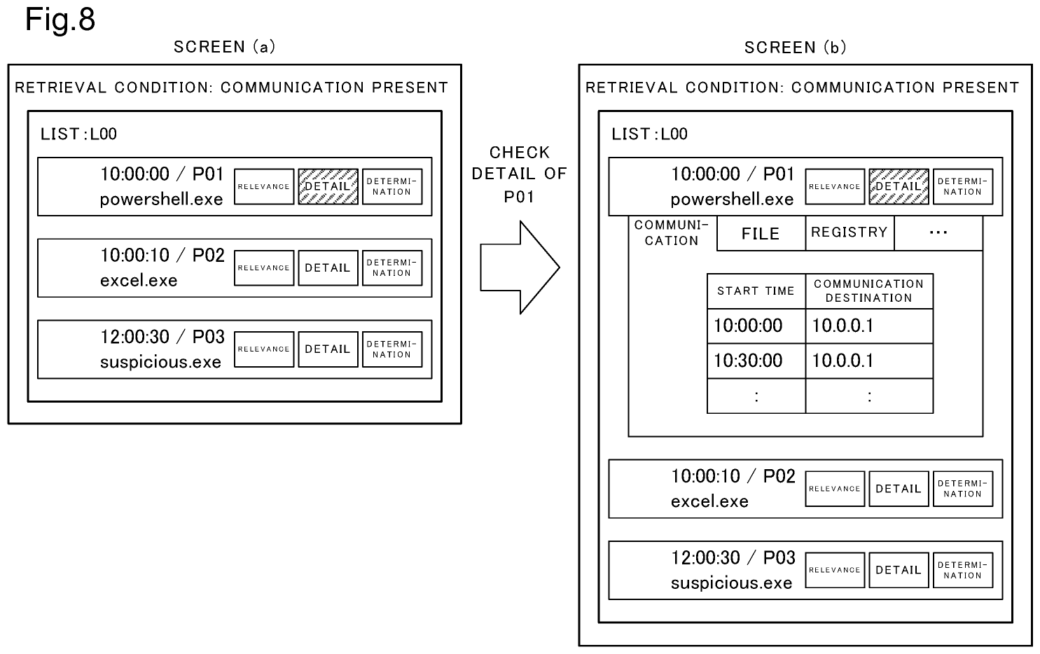

FIGS. 8, 9, and 10 are diagrams each illustrating an example of a screen generated in learning processing according to the first example embodiment.

For example, the reception unit 120 receives an execution order of the operation “display”, by an input of an initial retrieval condition “communication present” by the user. The display unit 130 extracts, from the terminal log in FIG. 5, processes “P01”, “P02”, and “P03” conforming to the retrieval condition “communication present”. The display unit 130 displays a screen (a) in FIG. 8 including a list “L00” of elements “P01”, “P02”, and “P03” indicating the processes.

Herein, for example, a process name (when a process communicating with a certain process is retrieved) of a communication destination, a file name or a registry name (when a process accessing a certain file or registry is retrieved) of an access destination, or the like is used in addition to “communication present”, as retrieval conditions initially input by the user.

The operation history collection unit 140 registers the operation “display” as an operation history of the elements “P01”, “P02”, and “P03” in the list “L00”, as in FIG. 7.

For example, the reception unit 120 receives an execution order of the operation “check”, due to clicking on a label “detail” of the element “P01” in the list “L00” and selection of a tag “communication” by the user. The display unit 130 extracts, from the terminal log in FIG. 5, detailed information relating to a communication of the process “P01”. The display unit 130 displays a screen (b) in FIG. 8 including the detailed information relating to the communication of the process “P01”.

Herein, for example, a file or a registry is used, in addition to communication, as a type of detailed information to be extracted.

The operation history collection unit 140 overwrites the operation history of the element “P01” in the list “L00” with the operation “check” over, as in FIG. 7.

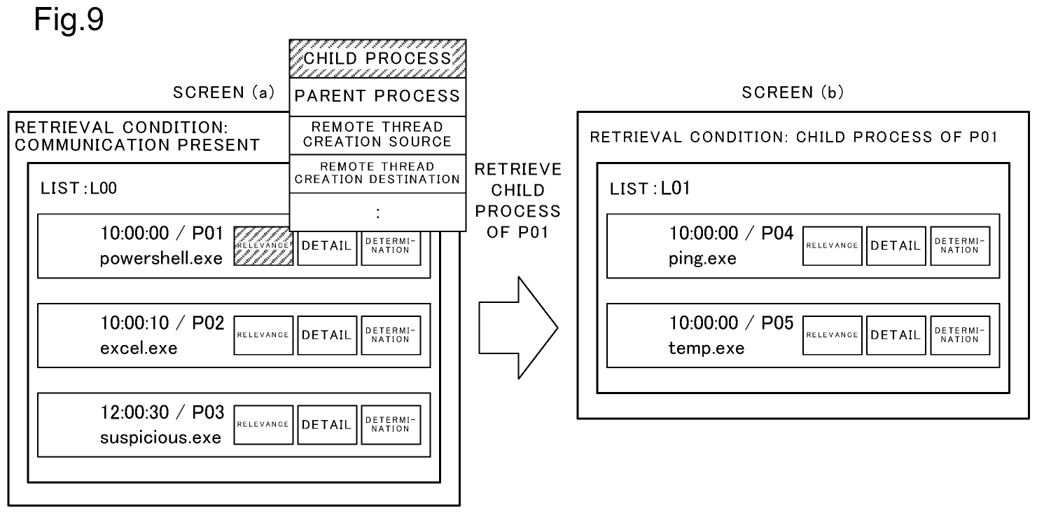

For example, the reception unit 120 receives an execution order of the operation “display”, due to clicking on a label “relevancy” of the element “P01” in the list “L00” and selection of relevancy “child process” by the user. The display unit 130 extracts, from the terminal log in FIG. 3, child processes “P04” and “P05” of the process “P01”. The display unit 130 displays a screen (b) in FIG. 9 including a list “L01” of elements “P04” and “P05” indicating the processes, following a screen (a) in FIG. 9.

Herein, for example, relevancy between processes, relevancy between a process and a file, or relevancy between a process and a registry is used as relevancy.

For example, a parent-child relation (a parent process and a child process) of a process, an acquisition relation (an acquisition destination process and an acquisition source process) of a process handle, a creation relation (a creation destination process and a creation source process) of a remote thread, and the like are used as the relevancy between processes. Herein, an ancestor process and a grandchild process may be used instead of the parent process and the child process, respectively. Overlap (an overlap process) of operation times, inter-process communication (communication destination process), or a same-name process (instances having the same process name) may be used as the relevancy between processes.

An access relation (a file accessed by a process, or a process accessing a file) is used as the relevancy between a process and a file. In this case, as a result of selection of relevancy, a file accessed by a process or a process accessing a file is retrieved and displayed.

Similarly, an access relation (a registry accessed by a process, or a process accessing a registry) is used as the relevancy between a process and a registry. In this case, as a result of selection of relevancy, a registry accessed by a process or a process accessing a registry is retrieved and displayed.

The operation history collection unit 140 registers the child list ID “L01” and the relevancy “child process” in the operation history of the element “P01” in the list “L00”, as in FIG. 7. The operation history collection unit 140 registers the operation “display” as an operation history of the elements “P04” and “P05” in the list “L01”.

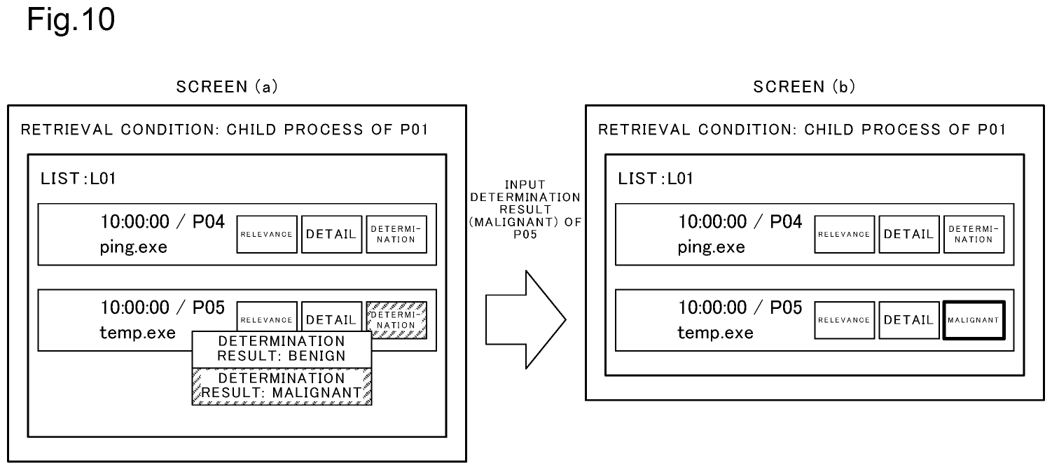

For example, the reception unit 120 receives an execution order of the operation “determination (malignant)”, due to clicking on a label “determination” of the element “P05” in the list “L01” and selection of a determination result “malignant” by the user. The display unit 130 gives the determination result “malignant” to the process “P05”. The display unit 130 displays a screen (b) in FIG. 10 in which the determination result “malignant” is given to the element “P05” indicating the process, following a screen (a) in FIG. 10.

The operation history collection unit 140 overwrites the operation history of the element “P05” in the list “L01” with the operation “determination (malignant)”, as in FIG. 7.

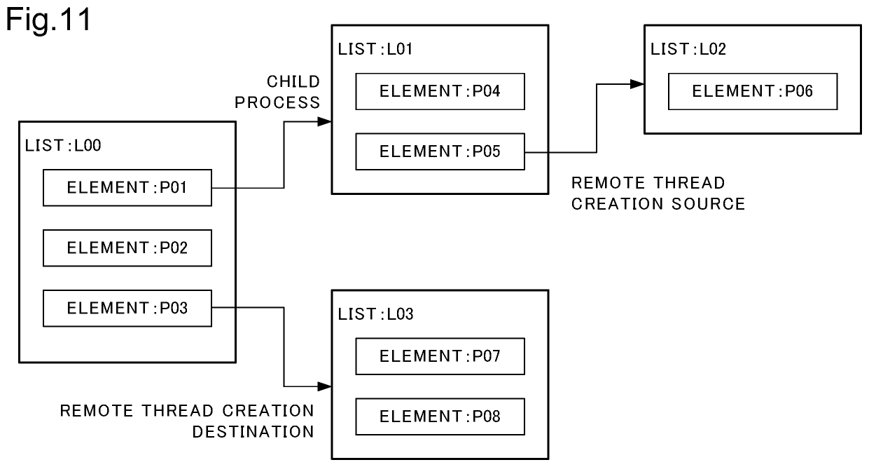

FIG. 11 is a diagram representing a relation between lists generated in learning processing according to the first example embodiment.

Thereafter, up until a search ends, an operation is executed in accordance with an order from the user, and an operation history is collected, in a similar manner. As a result, for example, a list is displayed as in FIG. 11, and an operation history is registered as in FIG. 7.

Next, the control unit 180 executes protection control, based on the determination result (step S106).

Herein, the control unit 180 orders, for example, the terminal device 200 to stop a process to which the determination result “malignant” is given, as the protection control. The control unit 180 may order the network device 210 to which the terminal device 200 is connected, to cut off a communication with a specific communication destination with which a process to which the determination result “malignant” is given communicates. The control unit 180 may present, to the user, a method of protection control executable for a process to which the determination result “malignant” is given, and execute the protection control in accordance with a response from the user.

Next, the feature extraction unit 150 generates a feature vector for each of the elements included in the operation history, based on the operation history and the terminal log (step S107).

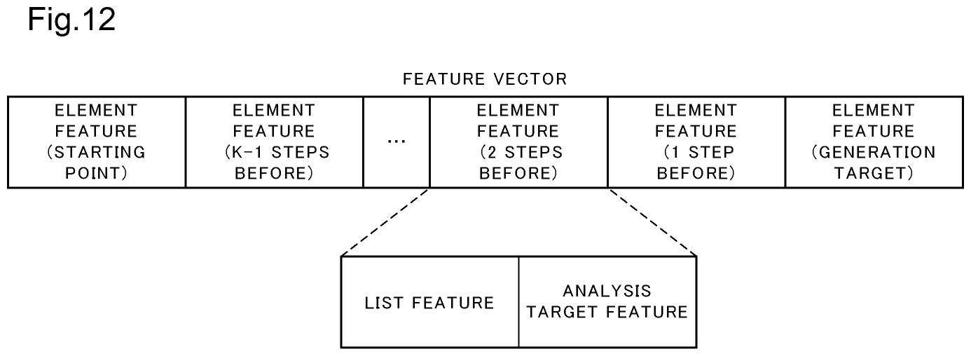

FIG. 12 is a diagram illustrating a configuration of a feature vector according to the first example embodiment. As illustrated in FIG. 12, a feature vector is generated based on a display history of an element from an element displayed K−1 (K is an integer being one or more) steps before an element being a generation target of the feature vector, up to the element being a generation target of the feature vector. Element features of K elements included in the display history are set in the feature vector in an order of display. An element feature of an element (acquired in an initial retrieval) at a starting point may be always included in the feature vector. Even when such an operation as returning to display of a previous element is performed before reaching an element being a generation target of a feature vector from the element at the starting point, an element feature of an element on a shortest path from the element at the starting point up to the element being a generation target may be set.

An element feature is a feature relating to an analysis target indicated by an element. As illustrated in FIG. 12, the element feature further includes an “analysis target feature” and a “list feature”. The analysis target feature is a feature representing an operation or a characteristic of an analysis target (a process, a file, a registry, or the like) itself indicated by an element. The list feature is a feature representing a characteristic of a list including the element.

When an analysis target is a process, the analysis target feature may include the execution number of the process, the number of child processes, and a process name of the process or a parent process. Herein, a child process may be a child process existing in a directory other than a predetermined directory. The analysis target feature may include the number of accesses for each extension of a file accessed by the process, the number of accesses for each directory, and the like. The analysis target feature may include the number of accesses for each key of a registry accessed by the process. The analysis target feature may include the number of communication destinations with which the process communicates, the number of communications for each of the communication destinations, and the like. The analysis target feature may include the number of indicators of attack for each type.

When an analysis target is a file, the analysis target feature may include a feature extracted from a file name, the number of accesses to the file for each access type, a data size during access to the file, and the like.

Likewise, when an element is a registry, the analysis target feature similarly includes a feature relating to a registry.

The list feature may include a feature relating to relevancy (relevancy selected for displaying a list) selected by the operation “check” for an element in a list displayed one step before the list is displayed. The list feature may include a depth from a starting point of the list. The list feature may include the number of elements in the list. The list feature may include the number of appearances or frequency of appearance for each process name in the list.

A list feature of an element at a starting point may include a feature relating to a character string of a retrieval condition used for retrieving the element. In this case, N-gram (the number of appearances of a combination of N characters) calculated for a retrieved character string may be used as a feature.

When an element feature of an element at a starting point is included in a feature vector, and when each element feature includes d (d is an integer being one or more) features, a feature vector becomes a d×(K+1)-dimensional vector.

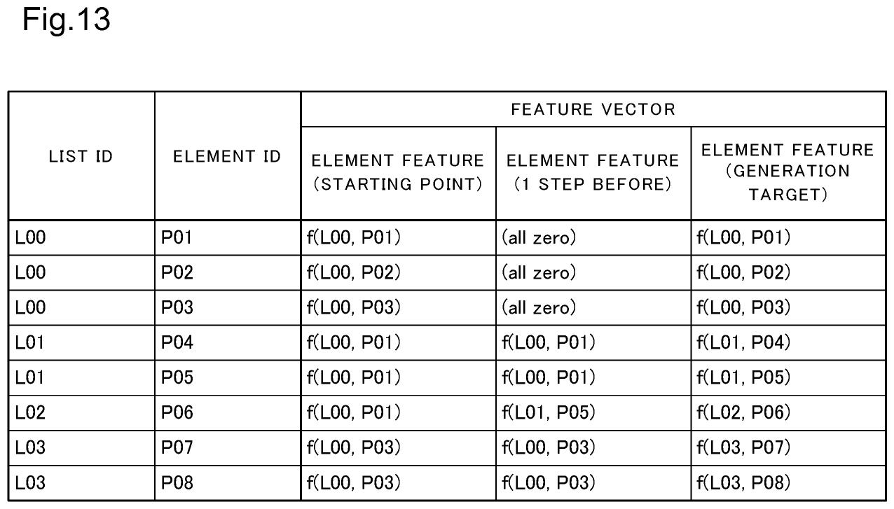

FIG. 13 is a diagram illustrating an example of a feature vector generated in learning processing according to the first example embodiment.

In FIG. 13, f(Lxx, Pyy) indicates an element feature calculated for an element Pyy in a list Lxx. In the example of FIG. 13, an element at a starting point, an element displayed one step before an element being a generation target of a feature vector, and a feature of the element being a generation target are set for the feature vector. When there is no element displayed in a certain step, “all zero” (values of an analysis target feature included in an element feature and all features within a list feature are 0) may be used as an element feature of the step.

For example, the feature extraction unit 150 generates a feature vector as in FIG. 13, for each element included in an operation history, based on the terminal logs in FIGS. 3 to 5 and the operation history in FIG. 7.

Next, the model generation unit 160 generates learning data, based on the operation history and the feature vector (step S108). Herein, the model generation unit 160 generates learning data by associating, for each element included in the operation history, an operation performed on the element with a feature vector generated for the element.

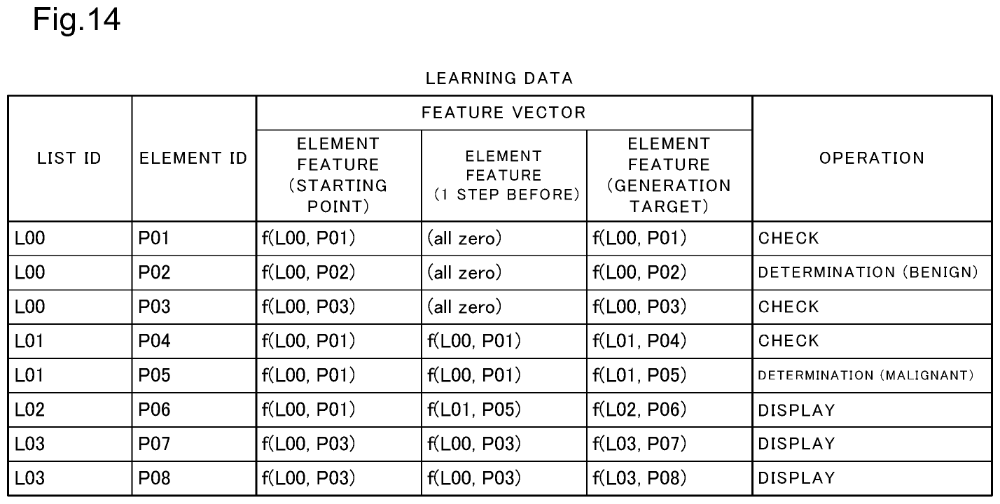

FIG. 14 is a diagram illustrating an example of learning data according to the first example embodiment.

For example, the model generation unit 160 generates learning data as in FIG. 14, based on the operation history in FIG. 7 and the feature vector in FIG. 13.

Next, the model generation unit 160 performs machine learning for learning data, and generates a model (step S109). The model generation unit 160 saves the generated model in the model storage unit 161.

Herein, the model generation unit 160 may generate, as a model, a regression model of outputting a numerical value of an importance degree from a feature vector, for example. In this case, an operation is converted into a numerical value (e.g., determination (malignant)=100, check=50, display=20, and determination (benign)=0) depending on the importance degree, and used for learning. In this case, for example, a neural network, random forest, a support vector regression, or the like is used as a learning algorithm.

The model generation unit 160 may generate, as a model, a classification model of outputting a class of an importance degree from a feature vector. In this case, an operation is converted into a class (e.g., determination (malignant)=A, check=B, display=C, and determination (benign)=D) depending on the importance degree, and used for learning. In this case, for example, a neural network, random forest, a support vector machine, or the like is used as a learning algorithm.

For example, the model generation unit 160 generates a regression model of outputting a numerical value of an importance degree from the feature vector, by use of learning data in FIG. 14.

<Proposition Processing>

Next, proposition processing by the analysis device 100 is described. The proposition processing is processing of determining proposition information for an element by use of a model generated by learning processing, and presenting the proposition information to a user. The proposition processing is performed in order to make a search more efficient during the search by a user having insufficient knowledge and experience, for example. The proposition processing may be performed during a search by a user other than a user having insufficient knowledge and experience.

Herein, it is assumed that a terminal log for a period of a predetermined length is stored in the terminal log storage unit 111 as a terminal log, in a way similar to the terminal logs in FIGS. 3 to 5.

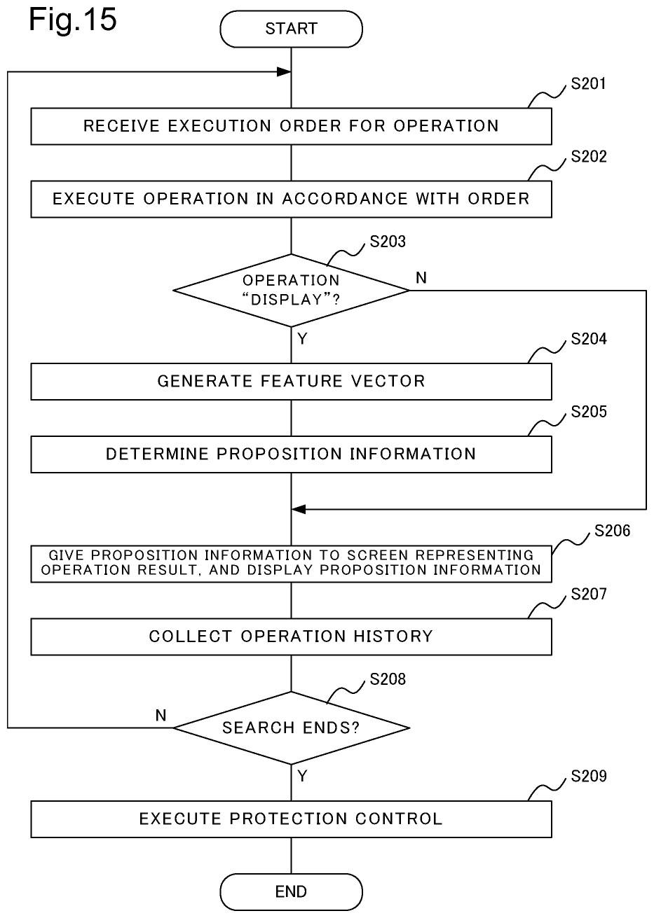

FIG. 15 is a flowchart illustrating proposition processing according to the first example embodiment.

In proposition processing, processing in the following steps S201 to S208 is performed during a search by a user.

The reception unit 120 receives, from the user, an execution order of an operation relating to an element (step S201).

The display unit 130 executes the operation in accordance with the order (step S202).

When the operation that the user orders to execute is “display” (step S203/Y), the feature extraction unit 150 generates a feature vector for each element acquired by retrieval, based on an operation history and a terminal log (step S204).

The proposition unit 170 determines proposition information for each element acquired by retrieval, by use of the feature vector and a model (step S205). Herein, the proposition unit 170 calculates an importance degree by applying the feature vector generated in step S204 to a model stored in the model storage unit 161. The proposition unit 170 outputs the calculated importance degree to the display unit 130.

The display unit 130 gives, to a screen representing a result of the operation, proposition information output from the proposition unit 170, and displays the proposition information (step S206). Herein, the display unit 130 gives an importance degree to each element included in a list.

The operation history collection unit 140 collects an operation history of the executed operation (step S207).

The analysis device 100 repeats the processing in steps S201 to S207 up until the search ends (step S208).

A specific example of the steps S201 to S208 in a search is described below.

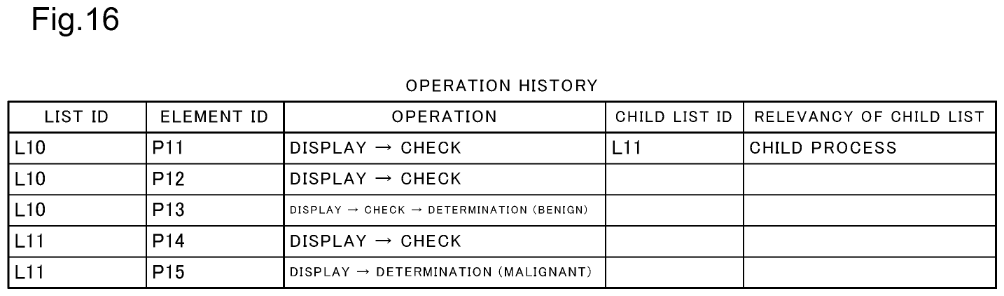

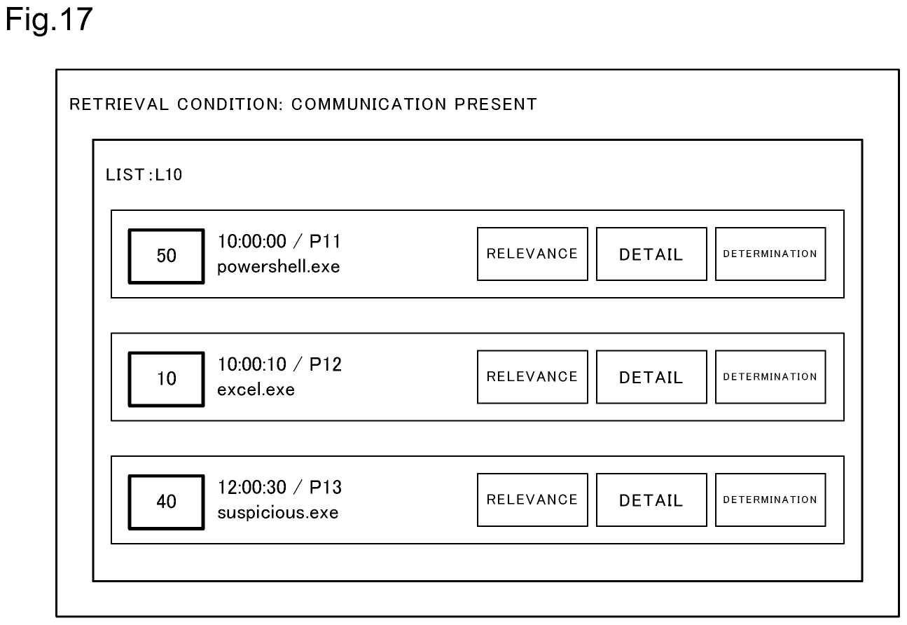

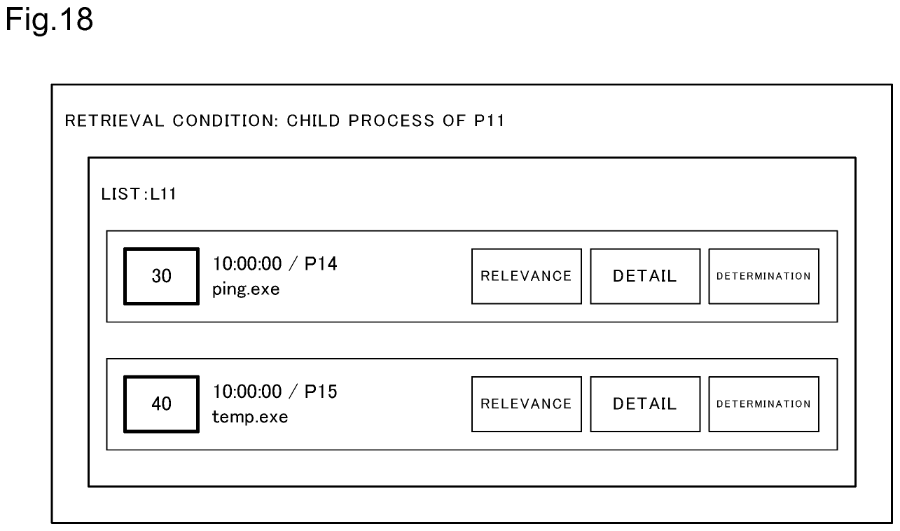

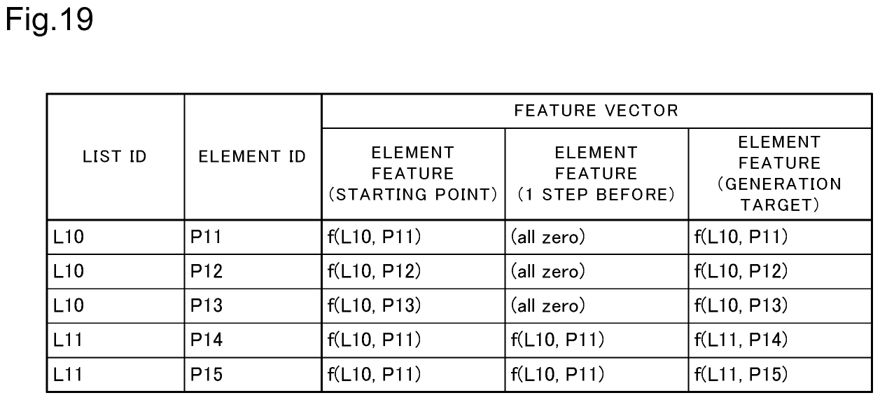

FIG. 16 is a diagram illustrating an example of an operation history generated in proposition processing according to the first example embodiment. FIGS. 17 and 18 are diagrams each illustrating an example of a screen generated in proposition processing according to the first example embodiment. FIG. 19 is a diagram illustrating an example of a feature vector generated in proposition processing according to the first example embodiment.

For example, the reception unit 120 receives an execution order of the operation “display”, by an input of an initial retrieval condition “communication present” by the user. The display unit 130 extracts, from a terminal log, processes “P11”, “P12”, and “P13” conforming to the retrieval condition “communication present”, and generates a list “L10” of elements “P11”, “P12”, and “P13” indicating the processes.

The feature extraction unit 150 generates a feature vector as in FIG. 19, based on the terminal log, for each of the elements “P11”, “P12”, and “P13” in the list “L10”.

The proposition unit 170 calculates importance degrees of the elements “P11”, “P12”, and “P13” in the list “L10” as, for example, “50”, “10”, and “40”, respectively, by applying the feature vector in FIG. 19 to a model generated by learning processing.

The display unit 130 displays a screen in FIG. 17, including the list “L10” to which the calculated importance degree is given.

The operation history collection unit 140 registers the operation “display” in the operation history of the elements “P11”, “P12”, and “P13” in the list “L10”, as in FIG. 16.

For example, the reception unit 120 receives an execution order of the operation “display”, due to clicking on a label “relevance” and selection of relevancy “child process” by the user, for the element “P11” to which a great importance degree is given in the list “L10”. The display unit 130 extracts, from the terminal log, child processes “P14” and “P15” of the process “P11”, and generates a list “L11” of elements “P14” and “P15” indicating the child processes.

The feature extraction unit 150 generates a feature vector as in FIG. 19, based on the terminal log and the operation history in FIG. 16, for each of the elements “P14” and “P15” in the list “L11”.

The proposition unit 170 calculates importance degrees of the elements “P14” and “P15” as, for example, “30” and “40”, respectively, by applying the feature vector in FIG. 19 to a model generated by learning processing.

The display unit 130 displays a screen in FIG. 18, including the list “L11” to which the calculated importance degree is given.

The operation history collection unit 140 registers a child list ID “L11” and the relevancy “child process” in the operation history of the element “P11” in the list “L10”, as in FIG. 16. The operation history collection unit 140 registers the operation “display” in the operation history of the elements “P14” and “P15” in the list “L11”.

As long as a difference of an importance degree can be distinguished, an importance degree may be represented by a color of a region of an element, a size or shape of a character, or the like, in a list. In a list, elements may be arranged in descending order of importance degrees. An element having an importance degree being equal to or less than a predetermined threshold value may be omitted from a list.

Thereafter, an operation is similarly executed in accordance with an order from the user up until the search ends.

The user can recognize, from an importance degree given to an element, an element to be operated with priority, and therefore, can efficiently execute a search for a suspicious process.

Next, the control unit 180 executes protection control, based on a determination result (step S209).

For example, when the determination result “malignant” is given to the process “P15”, the control unit 180 orders the terminal device 200 to stop the process “P15”. The terminal device 200 stops the process “P15”.

In consequence, the operation according to the first example embodiment is completed.

Next, a characteristic configuration of the first example embodiment is described.

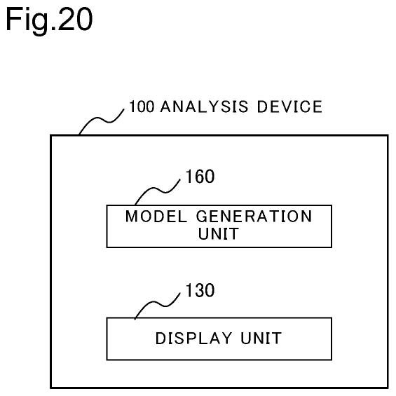

FIG. 20 is a block diagram illustrating a characteristic configuration according of the first example embodiment.

Referring to FIG. 20, the analysis device 100 includes the model generation unit 160 and the display unit 130. The model generation unit 160 generates a model of outputting information (proposition information) relating to an operation to be performed on an element, based on learning data including an operation performed on a displayed element (check target), and a display history of an element up until the displayed element is displayed. The display unit 130 displays an element, and information acquired by a model and relating to an operation to be performed on the element.

Next, an advantageous effect according to the first example embodiment is described.

According to the first example embodiment, a search in threat hunting can be efficiently performed. A reason for this is that the model generation unit 160 generates a model of outputting proposition information relating to an element, and the display unit 130 displays an element, and proposition information acquired by a model and relating to the element.

According to the first example embodiment, in threat hunting, a user can easily recognize an element to be operated with priority. A reason for this is that the model generation unit 160 generates a model of outputting an importance degree of an operation as proposition information, and the display unit 130 displays an importance degree of an operation of each element, acquired by the model.

According to the first example embodiment, in threat hunting, appropriate proposition information reflecting information to which an analyst pays attention can be presented. A reason for this is that the model generation unit 160 generates a model, based on learning data associating an operation performed on an element with a feature relating to an analysis target indicated by each element included in a display history. Generally, it is considered that, in threat hunting, an operation performed on a displayed element depends on a feature (a characteristic of an analysis target, or relevancy between analysis targets before and after an element) relating to an analysis target indicated by each element in a display history of the element. A model considering information to which an analyst pays attention is generated by using, as learning data, such a feature relating to an analysis target indicated by each element in a display history. Therefore, appropriate proposition information can be presented by the generated model.

### Second Example Embodiment

Next, a second example embodiment is described.

The second example embodiment is different from the first example embodiment in that a “content of an operation” is output as proposition information. A case where a content of an operation is a “type of detailed information” (hereinafter, also described as a “recommended type”) to be checked in an operation “check” is described below.

First, a configuration according to the second example embodiment is described.

A block diagram illustrating a configuration of an analysis device 100 according to the second example embodiment is similar to that according to the first example embodiment (FIG. 1).

An operation history collection unit 140 further registers, in an operation history similar to that according to the first example embodiment, a type of detailed information selected by a user in the operation “check”.

A model generation unit 160 generates learning data by associating the type of detailed information selected in the operation “check” with a feature vector. The model generation unit 160 generates a model of outputting a recommended type for an element as proposition information.

A proposition unit 170 determines a recommended type for an element by use of the model, and outputs the recommended type to a display unit 130.

The display unit 130 gives, to an element in a screen, the recommended type output from the proposition unit 170, and then displays the recommended type.

Next, an operation of the analysis device 100 according to the second example embodiment is described.

<Learning Processing>

First, learning processing of the analysis device 100 is described.

A flowchart illustrating the learning processing according to the second example embodiment is similar to that according to the first example embodiment (FIG. 6).

In step S104 described above, the operation history collection unit 140 further registers, in an operation history, a type of detailed information selected by a user in an operation “check”.

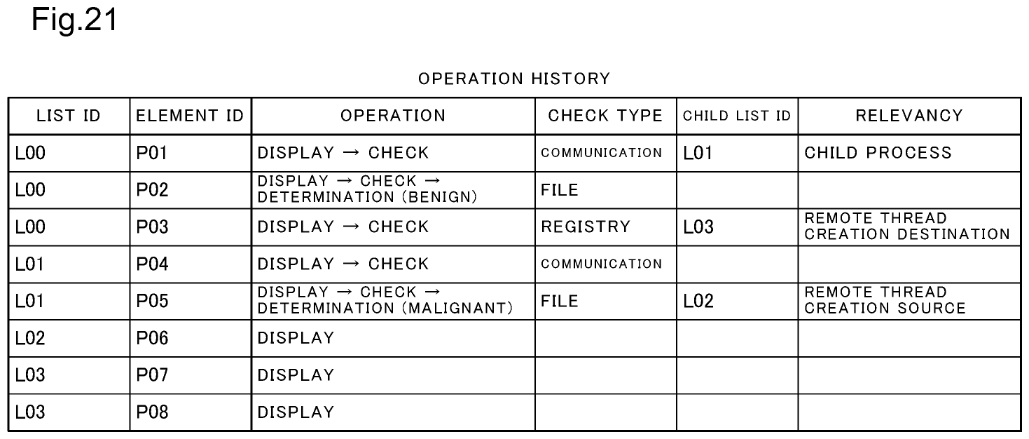

FIG. 21 is a diagram illustrating an example of an operation history generated in learning processing according to a second example embodiment.

In the example of FIG. 21, in addition to a list ID, an element ID, an operation, a child list ID, and relevancy similar to those according to the first example embodiment, a type (check type) of detailed information selected in an operation “check” is associated as an operation history.

For example, it is assumed that the display unit 130 displays a screen (b) in FIG. 8 including detailed information relating to a communication of a process “P01”, in accordance with clicking on a label “detail” of the element “P01” in a screen (a) in FIG. 8 and selection of a tag “communication”. In this case, the operation history collection unit 140 overwrites the operation history of the element “P01” in a list “L00” with the operation “check”, and registers a type “communication” of the selected detailed information in a check type, as in FIG. 21.

Thereafter, up until a search ends, an operation is executed in accordance with an order from the user, and an operation history is collected, in a similar manner. As a result, for example, an operation history is registered as in FIG. 21.

In step S108 described above, the model generation unit 160 generates learning data by associating, for each element on which the operation “check” included in the operation history is performed, a selected type of detailed information with a feature vector.

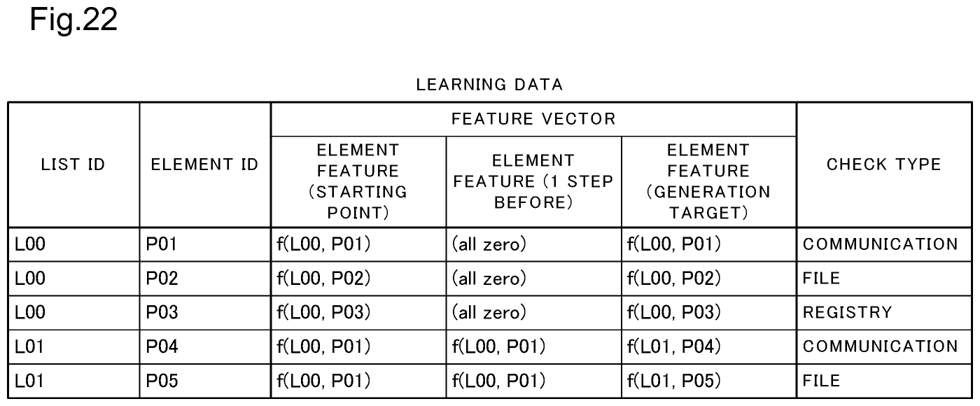

FIG. 22 is a diagram illustrating an example of learning data according to the second example embodiment.

For example, the model generation unit 160 generates learning data as in FIG. 22, based on the operation history in FIG. 21 and a feature vector in FIG. 13.

In step S109 described above, the model generation unit 160 generates, for example, a classification model of outputting a recommended type from the feature vector, by use of learning data in FIG. 22.

<Proposition Processing>

Next, proposition processing of the analysis device 100 is described.

A flowchart illustrating the learning processing according to the second example embodiment is similar to that according to the first example embodiment (FIG. 15).

In step S205 described above, the proposition unit 170 determines a recommended type by applying the feature vector generated in step S204 to a model.

In step S206 described above, the display unit 130 gives the recommended type to each element included in a list, and then displays the recommended type.

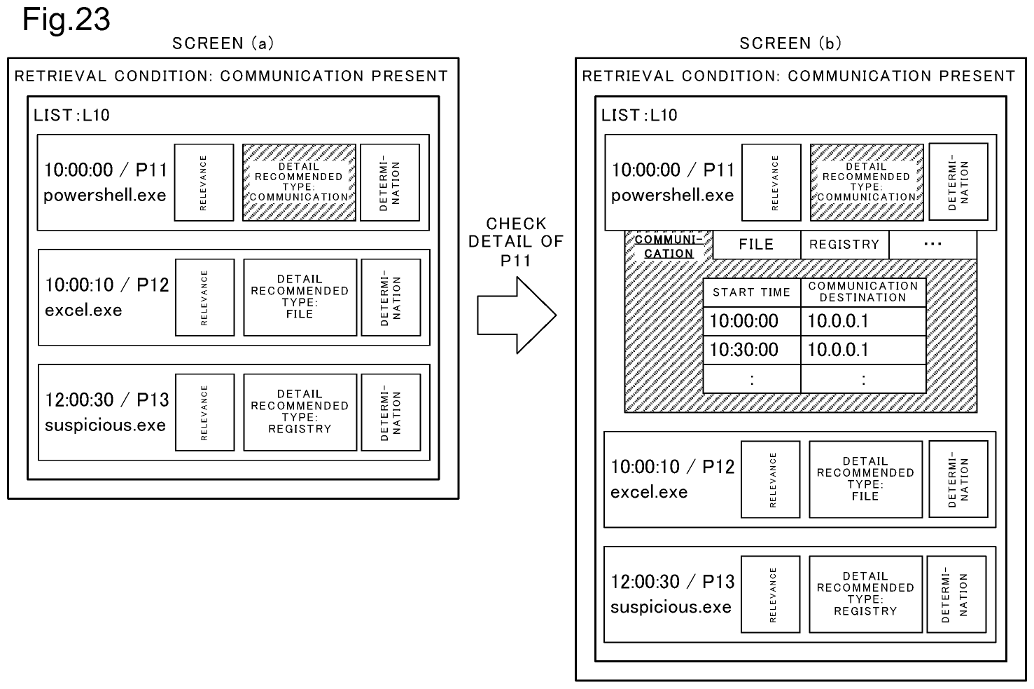

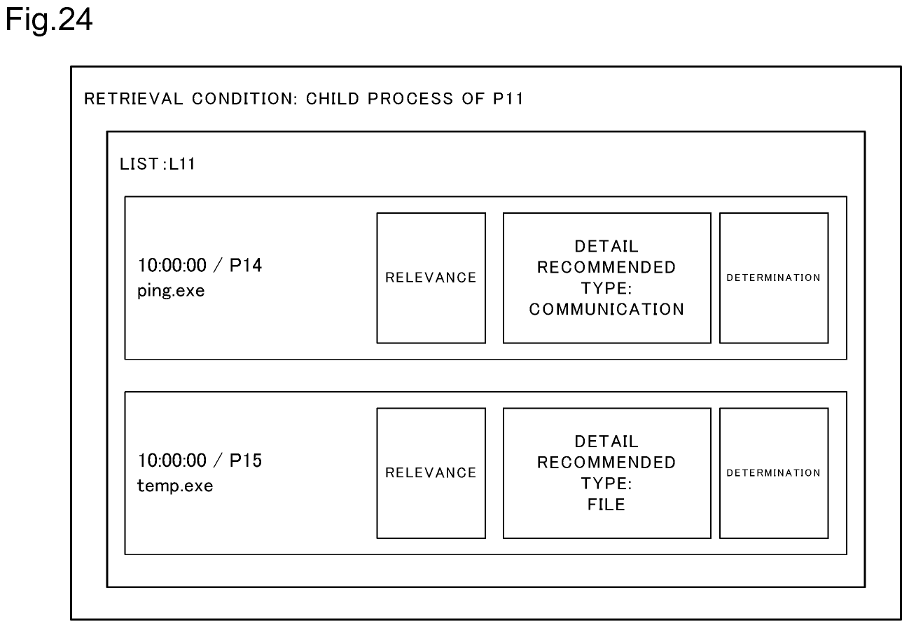

FIGS. 23 and 24 are diagrams each illustrating an example of a screen generated in proposition processing according to the second example embodiment.

For example, the reception unit 120 receives an execution order of the operation “display”, by an input of an initial retrieval condition “communication present” by the user. The display unit 130 extracts, from a terminal log, processes “P11”, “P12”, and “P13” conforming to the retrieval condition “communication present”, and generates a list “L10”.

The feature extraction unit 150 generates a feature vector as in FIG. 19, based on the terminal log, for each element “P11”, “P12”, and “P13” in the list “L10”.

The proposition unit 170 determines recommended types of the elements “P11”, “P12”, and “P13” as, for example, “communication”, “file”, and “registry”, respectively, by applying the feature vector in FIG. 19 to a model generated by learning processing.

The display unit 130 displays a screen (a) in FIG. 23 including the list “L10” in which the determined recommended type is given to a label “detail”.

In addition to giving of a recommended type to the label “detail”, the display unit 130 may display detailed information of the recommended type with priority or highlight the recommended type as in a screen (b) in FIG. 23, when the label “detail” is clicked. The display unit 130 may perform similar display instead of giving of a recommended type to the label “detail”.

For example, the reception unit 120 receives an execution order of the operation “display”, due to clicking on a label “relevance” and selection of relevancy “child process” by the user, for the element “P11” in the list “L10”. The display unit 130 extracts, from the terminal log, child processes “P14” and “P15” of the element “P11”, and generates a list “L11”.

The feature extraction unit 150 generates a feature vector as in FIG. 19, based on the terminal log and the operation history, for each of the elements “P14” and “P15” in the list “L11”.

The proposition unit 170 calculates recommended types of the elements “P14” and “P15” as, for example, “communication” and “file”, respectively, by applying the feature vector in FIG. 19 to a model generated by learning processing.

The display unit 130 displays a screen in FIG. 24 including the list “L11” in which the determined recommended type is given to the label “detail”.

Thereafter, up until a search ends, an operation is executed in accordance with an order from the user.

The user can recognize, from a recommended type given to an element, a type of detailed information to be checked, and therefore, can efficiently execute a search for a suspicious process.

Herein, a case where one recommended type is given to each element in a screen is described as an example. However, without being limited thereto, a plurality of recommended types may be given to each element. In this case, the model generation unit 160 generates, for each of the types of detailed information, a two-valued classification model of determining whether the type is recommended, for example. The proposition unit 170 determines one or more recommended types for each element by use of the model. The display unit 130 gives the one or more recommended types to each element in a screen, and then displays the recommended types.

In consequence, the operation according to the second example embodiment is completed.

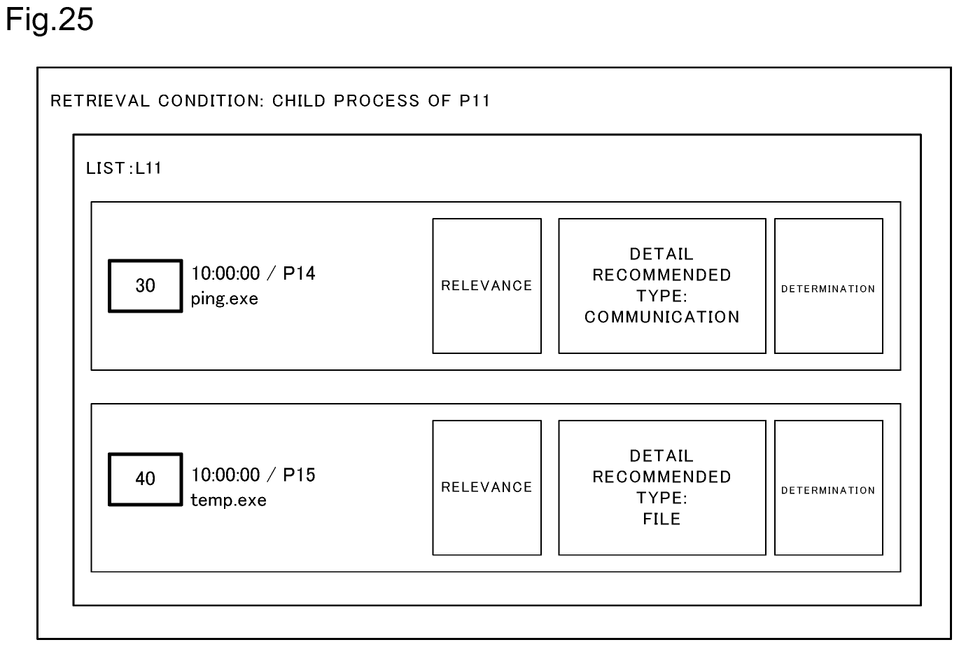

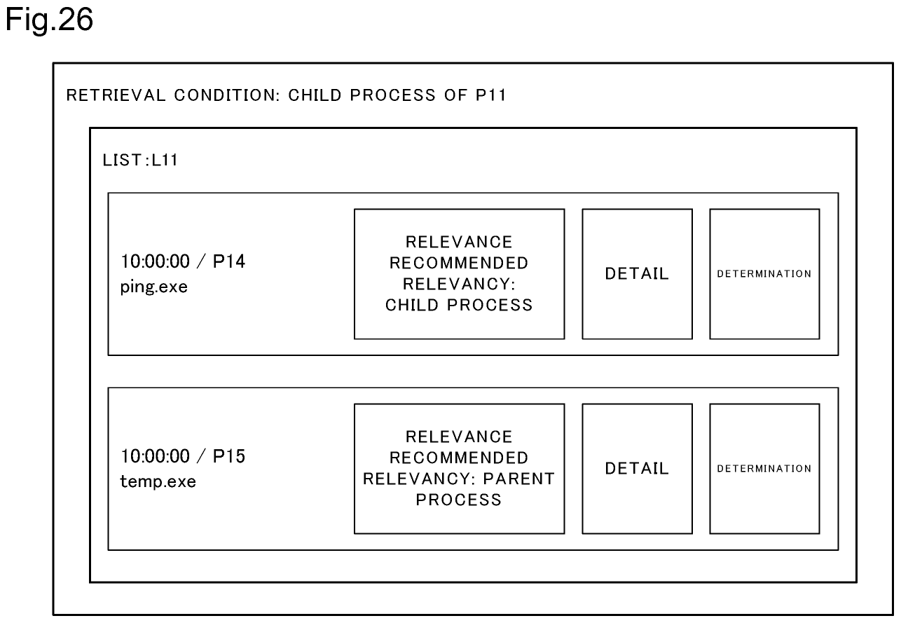

FIGS. 25 and 26 are diagrams each illustrating another example of a screen generated in proposition processing according to the second example embodiment.

As a specific example according to the second example embodiment, a case where a content of an operation is output as proposition information is described as an example. However, without being limited thereto, both an importance degree of an operation acquired according to the first example embodiment and a content of an operation acquired according to the second example embodiment may be output, as illustrated in FIG. 25.

As a specific example according to the second example embodiment, a case where a content of an operation is a type (recommended type) of detailed information to be checked in an operation “check” is described. However, without being limited thereto, a content of an operation may be relevancy (hereinafter, also described as a “recommended relevancy”) to another analysis target to be retrieved in an operation “display”, or the like, other than a recommended type.

In this case, the model generation unit 160 generates learning data by associating the relevancy selected in the operation “display” with a feature vector. The model generation unit 160 generates a model of outputting recommended relevancy for an element as proposition information. The proposition unit 170 determines recommended relevancy for an element by use of the model, and outputs the recommended relevancy to the display unit 130. The display unit 130 gives the recommended relevancy to a label “relevance” of an element in a screen, and then displays the recommended relevancy, as illustrated in FIG. 26. The display unit 130 may highlight the recommended relevancy in a screen displayed when the label “relevance” is clicked.

Next, an advantageous effect according to the second example embodiment is described.

According to the second example embodiment, in threat hunting, a user can easily recognize a content (a type of detailed information to be selected in the operation “check”, or relevancy to be selected in the operation “display”) of an operation to be performed on an element. A reason for this is that the model generation unit 160 generates a model of outputting a content of an operation as proposition information, and the display unit 130 displays a content of an operation of each element acquired by the model.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

100 Analysis device
101 CPU
102 Storage device
103 Input/output device
104 Communication device
110 Terminal log collection unit
111 Terminal log storage unit
120 Reception unit
130 Display unit
140 Operation history collection unit
141 Operation history storage unit
150 Feature extraction unit
160 Model generation unit
161 Model storage unit
170 Proposition unit
180 Control unit
200 Terminal device
210 Network device

What is claimed is:

1. An analysis device comprising:
a memory storing instructions; and
one or more processors configured to execute the instructions to:
generate a model of outputting information relating to an operation to be performed on a check target, based on learning data including an operation performed on a displayed check target, and a display history of a check target up until the displayed check target is displayed; and
display a check target, and information acquired from the model and relating to an operation to be performed on the check target.

2. The analysis device according to claim 1, wherein
the information relating to the operation includes at least one of an importance degree of the operation and a content of the operation.

3. The analysis device according to claim 2, wherein
the check target is information indicating an analysis target, and
the operation includes at least one of extraction of detailed information of an analysis target indicated by the check target from an event log relating to an analysis target, retrieval of another analysis target related to an analysis target indicated by the check target from the event log, and input of a determination result for an analysis target indicated by the check target.

4. The analysis device according to claim 3, wherein
the content of the operation includes at least one of a type of information to be extracted in extraction of the detailed information, and relevancy to be designated in retrieval of the another analysis target.

5. The analysis device according to claim 3, wherein
the one or more processors are configured to execute the instructions to:
when generating the model, generate the model, based on learning data associating an operation performed on the displayed check target with a feature relating to an analysis target indicated by each of one or more check targets included in the display history.

6. The analysis device according to claim 5, wherein
the operation includes retrieval of another analysis target related to an analysis target indicated by the check target from an event log relating to an analysis target, and
the feature relating to an analysis target indicated by each of the one or more check targets includes a feature of the analysis target, and a feature of relevancy designated by retrieval performed on a check target displayed before corresponding one of the one or more check targets.

7. The analysis device according to claim 3, wherein
the analysis target includes a process operating on a computer.

8. The analysis device according to claim 7, wherein
the analysis target further includes at least one of a file accessed by a process, and a registry accessed by a process.

9. An analysis method comprising:
generating a model of outputting information relating to an operation to be performed on a check target, based on learning data including an operation performed on a displayed check target, and a display history of a check target up until the displayed check target is displayed; and
displaying a check target, and information acquired from the model and relating to an operation to be performed on the check target.

10. A non-transitory computer-readable recording medium storing a program causing a computer to execute processing of:
generating a model of outputting information relating to an operation to be performed on a check target, based on learning data including an operation performed on a displayed check target, and a display history of a check target up until the displayed check target is displayed; and
displaying a check target, and information acquired from the model and relating to an operation to be performed on the check target.
